(19) United States
(12) Patent Application Publication
(10) Pub. No.: US 2026/0243320 A1
(43) Pub. Date: Aug. 20, 2026

(54) DRIVE MODULE OF A MOTOR VEHICLE AND METHOD FOR ACTIVATING A BRAKE AND A CLUTCH OF A DRIVE MODULE

(71) Applicant: GKN Automotive Limited, Birmingham, West Midlands (GB)

(72) Inventors: Hans Christian Irle, Lohmar (DE); Jan Haupt, Lohmar (DE); Andreas Mair, Lohmar (DE); Erik Seeber, Lohmar (DE)

(21) Appl. No.: 18/872,309

(22) PCT Filed: Oct. 19, 2022
(86) PCT No.: PCT/EP2022/079061

§ 371 Date: Dec. 6, 2024

(51) Int. Cl. F16D 67/04; B60L 15/20

(52) U.S. Cl. CPC F16D 67/04; B60L 15/2054

(57) ABSTRACT

A drive module of a motor vehicle includes at least a drive unit with a drive shaft and an axle of the motor vehicle with a first output shaft and a second output shaft, which can be connected to the drive shaft in a torque-transmitting manner via at least one clutch or in each case via a clutch in a torque-transmitting manner. The first output shaft can be braked by a first brake and the second output shaft can be braked by a second brake, and at least one of the brakes and the at least one clutch can be actuated by a common actuating unit.

### TECHNICAL FIELD

The present disclosure relates to a drive module for a motor vehicle and a method for actuating a brake and a clutch of a drive module.

### BACKGROUND

The drive module comprises at least one drive unit with a drive shaft and an axle of the motor vehicle with a first output shaft and a second output shaft, which can be connected to the drive shaft in a torque-transmitting manner via at least one clutch or in each case in a torque-transmitting manner via a clutch. The drive unit is, for example, an electric motor or an internal combustion engine. The output shafts are connected in particular to a wheel of the motor vehicle in each case. Either exactly one clutch or two clutches are provided on the axle.

The type of axle with one clutch is known as a so-called booster unit of the applicant, and an axle with two clutches is known as a twinster unit of the applicant.

In particular, electrically powered vehicles put less strain on conventional wheel-mounted brakes than conventionally powered vehicles with combustion engines due to the possibility of recuperation. The reduced load on the brakes results in less wear of components such as brake pads and discs, which are thus also more susceptible to corrosion. To counteract this, higher-quality materials must be used. At the same time, the brake system requires extensive maintenance to ensure its functionality.

The abrasion that occurs during braking with classic, open braking systems increases a motor vehicle's particulate emissions. The new laws to be introduced (Euro 7 emissions standard) will also include the particulate matter emitted by brake pads. For this reason, filter systems or encapsulation of the brakes are currently being considered.

System efficiency is playing an increasingly important role, particularly in the development of electric drives, which is why the reduction of losses, e.g. through shut-off devices, is increasingly being discussed. To achieve a correspondingly high effect, the shut-off should be positioned as close as possible to the respective wheel, so that the smallest possible masses are moved along with the wheels. This requires a certain amount of additional work due to additional components such as a shut-off unit in the area of the wheelset drive.

An electric drive module is known from DE 10 2020 123 806 A1, in which an electric drive unit and a brake are provided for each wheel. The brake can be designed as a multi-disc clutch.

A drive unit is known from DE 10 2020 214 433 A1, in which the wheels of an axle are driven by an electric motor. A brake is provided for each wheel, which has a common lubricant circuit with the drive unit's transmission.

The object of at least some implementations of the present disclosure is to provide a drive module and a method for its operation in which particulate emissions and brake corrosion can be reduced and the system efficiency of the drive module can be improved. Furthermore, a better control of the transition between recuperation and braking is to be achieved.

### SUMMARY

A drive module according to the features of claim 1 contributes to this. Advantageous further developments are the subject of the dependent claims. The features listed individually in the claims can be combined with each other in a technologically meaningful way and can be supplemented by explanatory facts from the description and details from the figures, whereby further embodiments of the disclosure are shown.

A drive module for a motor vehicle is proposed, comprising at least a drive unit with a drive shaft and an axle of the motor vehicle with a first driven shaft and a second driven shaft, which can be connected to the drive shaft in a torque-transmitting manner via at least one clutch or in each case in a torque-transmitting manner via a clutch. The first output shaft can be braked by means of a first brake and the second output shaft can be braked by means of a second brake. At least one of the brakes and the at least one clutch can be actuated by means of a common actuating unit.

The drive unit is, for example, an electric motor or an internal combustion engine.

The output shafts are connected in particular to a wheel of the motor vehicle in each case.

Either exactly one clutch or two clutches are provided on the axle. In particular, the two output shafts can be decoupled from the drive shaft via the one clutch. If two clutches are provided, one output shaft can be decoupled from the drive shaft by means of a clutch in each case.

The brakes serve to brake the respective output shafts. In particular, the brakes act (exclusively) in a force-locking manner, so that they generate the braking effect (exclusively) via a frictional force.

In particular, each output shaft or each wheel of the axle of the motor vehicle is assigned a brake.

In particular, an actuating unit is provided, by means of which at least one brake and the one clutch can be actuated. Alternatively, both brakes and the one clutch can be actuated by means of the one actuating unit. Alternatively, both brakes and both clutches can be actuated by means of an actuating unit.

Alternatively, two actuating units are provided, whereby one brake and one clutch can be actuated via each actuating unit. Alternatively, one brake and one clutch can be actuated via the one actuating unit and the other brake can be actuated via the other actuating unit.

The generally known actuating unit is used in particular to actuate a brake, i.e. to adjust the brake between an open (first) and a closed (second) state. In the open state, there is in particular no braking effect. In the closed state, there is in particular a maximum braking effect.

The generally known actuation unit is used in particular (additionally) to actuate a clutch, i.e. to adjust the clutch between an open (first) and a closed (locked, second) state. In the open state, there is in particular no coupling between the input shaft and the output shaft that can be connected to the input shaft via the clutch. In the closed or locked state, there is in particular a coupling between the input shaft and the output shaft that can be connected to the input shaft via the clutch. In particular, there is a slip-free coupling in the closed state, i.e. the input shaft and the output shafts connected to it have no speed difference. In particular, however, a freely adjustable coupling can be realized via the clutch, i.e. a defined slip, i.e. a speed difference between the input shaft and the output shaft, can be permitted or set.

The basically known actuating unit serves to displace at least part of the brake or clutch so that this part can be moved towards or away from a part that can be connected to it (in particular in a force-locking manner). The displacement may be adjustable so that the displaceable part can assume a variety of positions between the open state and the closed state.

However, the displacement can also be non-adjustable, so that the displaceable part between the open state and the closed state cannot take any other positions. This type of displacement is particularly possible with form-fitting couplings, e.g. with claw couplings/dog clutches.

The actuation unit proposed here is used to actuate the brake and the clutch. This means that a common actuation unit is proposed for at least one clutch and one brake, so that the drive module is equipped with a smaller number of components.

In particular, an (electrical) drive module with a shut-off function (realized via the at least one clutch) and an integrated, in particular fully encapsulated, braking function is proposed, in which the shut-off unit (the at least one clutch) and the brakes of the axle are installed in a single unit or module.

The drive module has the highest possible efficiency due to the possibility of disconnection (close to the wheel).

In addition, the functional integration of the brake into the drive module makes it possible to arrange the brakes in a housing that is closed to the environment, thus eliminating the particulate emissions of the motor vehicle during the braking process.

In order to achieve this with the least possible effort, in particular, a common control of the switch-off and braking unit via at least one common actuating unit is proposed.

In particular, the drive module may have only one clutch and the output shafts and the clutch are connected to the input shaft via a common differential. The generally known differential can be used in particular to compensate for speed differences between the output shafts, e.g. when driving along a curve where the path of one wheel is shorter or longer than the path of the other wheel on the axle. The one clutch arranged on the axle can be used in combination with the differential to couple both output shafts to the input shaft.

In particular, the drive module has a first clutch and a second clutch, wherein the first brake and the first clutch can be actuated by means of a first actuation unit and the second brake and the second clutch can be actuated by means of a second actuation unit.

In particular, two clutches are provided on a common axle of the motor vehicle, with each of the two clutches connecting a wheel of the motor vehicle to the drive unit in a torque-transmitting manner.

The two clutches can replace the conventional differential, which can compensate for different speeds of the wheels.

The design of such clutches and drive systems can be described as follows. For example, multi-disc clutches can be used as clutches, in which outer discs are connected to an outer disc carrier and inner discs are connected to an inner disc carrier in a rotationally fixed manner and each disc carrier is connected to the input shaft (or to a shaft connected to the input shaft via a gearbox) or to the respective output shaft in a rotationally fixed manner. As a result of the application of a closing force acting in an axial direction (due to the actuation pressure), the lamellae, or in the case of other clutches the friction partners, are brought into contact with each other so that a torque can be transmitted from the input shaft to the respective output shaft via the clutch.

At least one clutch can be an hydraulically actuated clutch, which may be both clutches. In the case of an hydraulically actuated clutch, the actuation pressure is transmitted to the clutch via a (hydraulic) fluid. The fluid can be pressurized by means of a pump (which can alternatively be operated electrically).

At least one of the two clutches can be an electrically actuated clutch, which may be both clutches. In the case of an electrically actuated clutch, the actuating pressure is generated directly by an electric machine, e.g. by a ramp arrangement that can be rotated by the machine.

In particular, the at least one actuating unit is accordingly an electromechanical or hydraulic actuating unit.

In a generally known electromechanical actuation unit, a part of the clutch can be mechanically displaced by means of an electric drive. For example, DE 101 60 026 A1 discloses an actuation mechanism having several discs and ball grooves and balls arranged in between. Different parts, e.g. a part of a clutch and a part of a brake, can be actuated successively, i.e. one after the other, by the one actuating unit. The discs can be rotated by an electric drive controlled by the actuating unit, so that the displacement of the discs and thus the pressure force of the brake or the degree of coupling of the clutch can be adjusted.

In a generally known hydraulic actuation unit, one part of the clutch is hydraulically actuated, e.g. by means of a fluid that can be pressurized by a pump. In particular, the fluid can be pressurized in a common pressure chamber. The fluid can then, starting from the pressure chamber, act on the part to be moved via a respective adjustable valve, so that several parts can be acted on or shifted simultaneously by the actuation unit. In particular, several valves can also be controlled independently of one another in the case of the one actuation unit and thus be actuated or regulated.

In particular, the actuating units of the drive module are each hydraulic actuating units which actuate the brake and the clutch via a fluid, the actuating units having a common pump by means of which the fluid can be pressurized. Alternatively, each actuating unit can also have its own pump. In particular, the actuating units have a common fluid circuit, i.e. the fluid can be used both for actuating the first brake and/or first clutch and for actuating the second brake and/or second clutch. Alternatively, separate fluid circuits can also be provided.

In particular, as a result of the operation of each of the clutches, one wheel at a time of the common axle of the motor vehicle can be connected to the drive unit in a torque-transmitting manner.

At least one clutch may be a multi-disc clutch, in particular both clutches are a multi-disc clutch. However, the respective clutch can also be designed as any other known friction clutch or as a claw coupling/dog clutch that acts in a form-fitting manner.

The drive unit may be an electric machine. In particular, the electric machine can be the only drive unit used to drive the motor vehicle. In particular, there can also be a second driven axle, with a further drive unit being provided to drive the second axle (e.g. an internal combustion engine or a further electric machine).

In particular, the at least one clutch is a slip-controlled clutch, by means of which a torque provided by the drive unit can be transferred in a controlled manner to the output shaft(s) connected to the drive unit via the clutch by providing a slip (i.e. a speed difference between the drive shaft and the output shaft that can be connected to it via the clutch).

In particular, both clutches can be operated (at least) at certain operating points (in particular constantly during the operation of the motor vehicle) with a slip control, in which a speed difference between the input shaft and the respective output shaft of more than zero revolutions per minute and at most 50 revolutions per minute, in particular at most 20 revolutions per minute, is set at the respective clutch. In particular, the clutches can also be operated without slip control, i.e. when no speed difference is set between the input shaft and the output shaft (or a speed difference of zero revolutions per minute). In a stable driving state, the clutches are controlled in such a way that the total locking torque of both clutches corresponds to (at least) a drive torque provided by the input shaft.

In particular, the drive unit may be assigned exclusively to the axle (and not additionally to another axle), so that only the wheels of the axle (and not the wheels of another axle) can be driven by the drive torque provided by the drive unit.

A motor vehicle may have an additional driven axle, which in turn can be driven by a further drive unit (e.g. an internal combustion engine).

A slip control system involves setting a differential speed greater than zero revolutions per minute at the clutch at all times, if possible. Excessive differential speeds should be avoided, as the slip in the clutch generates frictional heat. This frictional heat can lead to overloading of the clutch.

In particular, the slip control ensures that, in a stable driving condition, the drive torque provided by the drive unit always exactly matches the torques that are transmissible between the wheels, which are connected to the clutches, and the road surface. In this case, the total locking torque of both clutches (that is, the transmissible torque of both clutches together) corresponds at least or essentially (or even exactly) to the drive torque provided by the drive unit via the drive shaft. The total locking torque deviates from the drive torque by at most 1%, or by at most 0.5%.

In particular, if the slip becomes too small, the slip control opens the clutch again to such an extent that the drive unit is accelerated and the desired slip is achieved. In this case, a slightly lower total locking moment is transmitted via the clutches, temporarily or if necessary.

Furthermore, the tuning of the motor vehicle or the drive system can be simplified because the torque requirement is always set according to the slip present. This means that parameterization of controllers is no longer necessary or is less complex than in conventional controllers for all-wheel drive trains.

The control of the drive system can thus be carried out independently of the control of the drive unit. This is particularly advantageous if an operating strategy (e.g. a hybrid strategy for driving a hybrid vehicle) is provided by other manufacturers (than the manufacturer of the control unit controlling the clutches).

The degree of locking of a clutch particularly defines the torque that can be transmitted via the clutch. The higher the degree of locking, the higher the torque that can be transmitted (or is transmitted) via the clutch. In particular, over-locking can also occur, so that a torque greater than that provided by the drive unit could be transmitted. However, in this case there is no slip.

In the drive module described, the desired degree of locking for each of the two clutches for the stable driving state (in which neither of the driven wheels spins freely or locks, i.e. does not slip on the road surface), in particular, is determined as a function of at least one of the following parameters (preferred of all): a steering angle of the motor vehicle, the torque transmitted via the drive shaft (drive torque or drag torque or recuperation torque), the speed of the motor vehicle and the measured yaw rate.

In particular, a total locking moment of the two clutches should be large enough to apply the drive torque and to “hold” the drive unit. To do this, the slip (i.e. a difference in speed) in at least one of the clutches should be close to zero (but greater than zero), in particular no more than 50 revolutions per minute, or no more than 20 revolutions per minute, and may be no more than 5 revolutions per minute.

In particular, it is possible to deviate from this distribution of the torques and the locking degrees of the two clutches as soon as the stable driving state is left. This is the case if at least one of the wheels spins freely or locks (i.e. slips with respect to the road surface). In this case, the degree of locking of the clutch of the wheel that is spinning can be reduced or the degree of locking of the wheel(s) that is/are not spinning can be increased. In particular, a reduction in the degree of locking should only be carried out in conjunction with a reduction in the torque transmitted via the drive shaft (drive torque or drag torque or recuperation torque).

In particular, a desired distribution of the torques may be determined as a function of at least one of the following parameters (preferred of all): a steering angle of the motor vehicle, the torque transmitted via the drive shaft (drive torque or drag torque or recuperation torque), the speed of the motor vehicle and the measured yaw rate. The desired distribution is specified, for example, as a percentage distribution factor (e.g. 40/60: 40% of the torque transmitted via the drive shaft is transmitted via the first clutch and 60% via the second clutch), which corresponds to the driving dynamics requirements for the desired driving behavior of the motor vehicle for stable driving maneuvers. This control of the torque transmitted via each clutch is also referred to as torque vectoring. In addition, controlled actuation of the brake can also be used to stabilize the vehicle. By integrating the clutch and brake, the vehicle-stabilizing functions of both systems can be linked in the best possible way.

As soon as one of the wheels slips (spins freely or locks) relative to the road surface, the desired distribution can be corrected. To increase traction or stabilize the vehicle, the distribution is usually changed so that the degree of lock of the non-slipping wheel is increased and/or the degree of lock of the slipping wheel is reduced. If the overall degree of lock (the total locking torque) is reduced, the torque provided by the drive unit should (also) be reduced. If the torque provided by the drive unit is not reduced, the speed of the drive shaft will increase further compared to the speeds of the output shafts or compared to the speed of the slipping output shaft and thus the slip at the clutch.

Using the torque transmitted via the input shaft (input torque or drag torque or recuperation torque) and the desired distribution or corrected distribution of the torque, the desired degree of locking of the respective clutch for the first wheel or second wheel can be calculated. The sum of the locking torque (the total locking torque) of the clutches can correspond exactly to the torque transmitted via the input shaft or fluctuate with a small deviation around the exact value of this torque (e.g. with less than 1% deviation or less than 0.5% deviation). Alternatively, a clutch of an outer wheel on the curve can be over-locked to an extent that corresponds to a torque setting accuracy of the clutches and the drive unit. This can ensure that all of the torque supplied via the drive shaft is transmitted to the wheels via the clutches.

In particular, the at least one clutch can also be opened completely so that the drive unit is decoupled from the wheels.

In particular, the brakes may be supported on a housing of the drive module.

In particular, the drive module comprises at least one housing in which at least the at least one clutch and the brakes as well as the at least one actuating unit are arranged. The housing thus may enclose a volume that may be separated from the environment of the drive module, so that, for example, particles generated within the housing cannot escape into the environment. In particular, there may be subvolumes within the housing of the drive module, which may be separated from each other. In particular, for example, each brake or the components of the brake that interact in a force-locking manner to generate the braking effect are arranged within their own volume, so that particles generated by the brake cannot contaminate other components of the drive module.

In particular, the output shafts may be connected to the input shaft via a gearbox that has a constant or variable transmission. In particular, the gearbox can have several different transmissions that can be selected as required. Variable transmission means, in particular, that there is not a single constant transmission, but that the transmission can be changed, e.g. in stages or even continuously.

Alternatively, no gearbox or a gearbox with a single fixed ratio can be arranged between the drive unit and the output shafts.

Furthermore, a method for actuating a brake and a clutch of the described drive module is proposed, wherein the at least one brake and the at least one clutch are actuated by the at least one common actuation unit and thus an operation of the at least one output shaft is controlled. The method comprises at least the following steps:
a) actuating the (respective) brake with the actuating unit, so that the (respective) driven shaft is braked;
b) actuating at least the one clutch with the actuating unit, so that at least one of the driven shafts is adjustably connected to the input shaft of the drive unit or is adjustable by the input shaft of the drive unit.

In particular, steps a) and b) are carried out at different time intervals, so that when the clutch is controlling the connection between the drive shaft and at least one output shaft, the brake is open and is not actuated.

Alternatively, steps a) and b) are carried out at least partially in parallel.

The above (non-exhaustive) classification of the method steps into a) and b) is intended primarily for differentiation purposes only and does not enforce any order and/or dependency. The frequency of the method steps, e.g. during the set-up and/or operation of the drive module, can also vary. It is also possible that the method steps overlap at least partially in time. In particular, method steps a) and b) take place at different time intervals.

In particular, the at least one clutch is a slip-controlled clutch; wherein, when controlling a torque to be transmitted between the input shaft and at least one of the output shafts, a speed difference between the input shaft and the at least one output shaft of more than zero revolutions per minute and at most 50 revolutions per minute is set.

Alternatively, the at least one clutch is a form-fitting clutch, e.g. a claw coupling/dog clutch, which is not currently being slip-controlled, but can only be switched back and forth between a coupled state and an uncoupled state.

In particular, the brakes are only applied when the at least one clutch is not controlling the transition between the open state and the closed state (in which there is no slip or the predetermined slip of less than 50 revolutions per minute). The brakes are therefore open while the clutch is being controlled, so that a braking torque of the applied brake does not disturb or influence the control of the clutch, in particular the torque transmission from the input shaft to the respective output shaft, which is controlled via the clutch.

If the clutch is open, the brake may be applied. Even when the clutch is closed (or when there is controlled slip of less than 50 revolutions per minute), it may be possible to actuate the brake. In particular, the brake can be actuated when recuperation is taking place (i.e. when a battery is being charged via the input shaft driven by the output shafts) and the clutch is closed for this purpose.

Furthermore, a motor vehicle is proposed, at least comprising two wheels and the described drive module for driving at least one axle of the motor vehicle, on which the wheels are arranged. The drive module further comprises a control unit by means of which the described method can be carried out.

The control unit may be suitable for carrying out the method and/or is set up to carry out the method.

The control unit can be used, for example, to control the actuating unit(s) and thus to regulate the clutch(es) and actuate the brake(s). Furthermore, the control unit may also be used to regulate the drive unit and thus the torque provided.

In particular, the two clutches are arranged on an axle of a motor vehicle for transmitting torques, so that by actuating the first clutch a first wheel of an axle and by actuating the second clutch a second wheel of the same axle of the motor vehicle is connected to the drive unit in a torque-transmitting manner. In particular, the clutches are not a clutch of a motor vehicle that is arranged between the drive unit and a shiftable transmission of the motor vehicle.

In particular, at least one system for data processing is provided that has means that are suitably equipped, configured or programmed for carrying out the method or that execute the method.

In particular, the drive module comprises a data processing system, e.g. the control unit, which has means for executing the steps of the method and/or which has means that are suitably equipped, configured or programmed to execute the steps of the method or that execute the method.

The means include, for example, a processor and a memory in which instructions to be executed by the processor are stored, as well as data lines or transmission devices that enable the transmission of instructions, measurement values, data or similar between the elements listed.

The “means” may include, one or more of the following components: controller(s), microcontroller, data memory, data link, display devices (such as a display), counter or timer, at least one further sensor, a power source, etc.

Furthermore, a computer-readable storage medium is proposed, comprising instructions that, when executed by a computer, cause the computer to execute the method or the steps of the method described.

The explanations regarding the drive module may be applicable to the method, the drive train, the data processing system and/or the computer-implemented method (i.e. the computer program and the computer-readable storage medium) and vice versa.

As a precaution, it should be noted that the words used here (“first”, “second”, . . . ) primarily serve to distinguish between several similar objects, sizes or processes, and in particular do not necessarily imply any dependency and/or sequence of these objects, sizes or processes in relation to one another. If a dependency and/or sequence is required, this is explicitly stated here or is obvious to a person skilled in the art when studying the specifically described design.

### BRIEF DESCRIPTION OF THE DRAWINGS

The disclosure and the technical environment will be explained in more detail below on the basis of the figures. It should be noted that the disclosure is not to be limited by the examples shown. In particular, unless explicitly stated otherwise, it is also possible to extract partial aspects of the facts explained in the figures and to combine them with other components and findings from the present description and/or figures. The same reference signs denote the same objects, so that, if necessary, explanations from other figures can be used in addition. The following figures show schematically:

FIG. 1 a first design variant of a drive module of a motor vehicle;

FIG. 2 a second design variant of a drive module of a motor vehicle; and

FIG. 3 a diagram.

### DETAILED DESCRIPTION

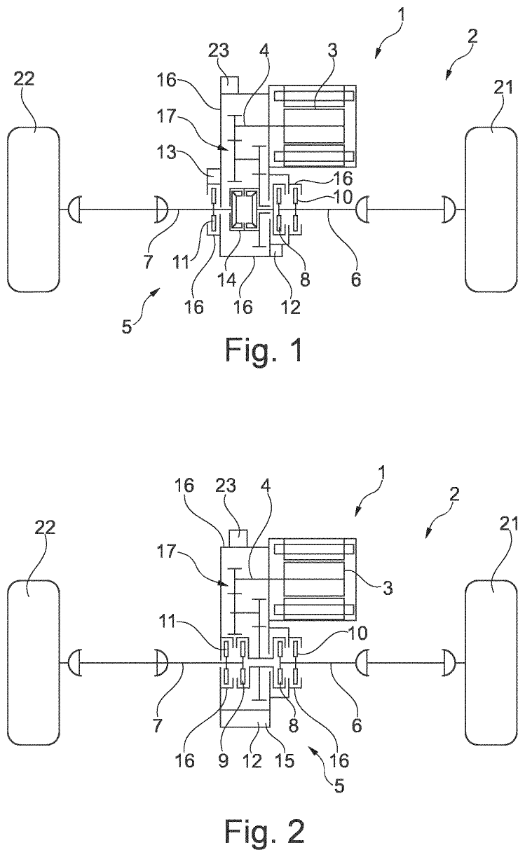

FIG. 1 shows a first design variant of a drive module 1 of a motor vehicle 2. FIG. 2 shows a second design variant of a drive module 1 of a motor vehicle 2. FIGS. 1 and 2 are described together below.

The drive module 1 comprises a drive unit 3 with a drive shaft 4 and an axle 5 of the motor vehicle 2 with a first output shaft 6 and a second output shaft 7, which can be connected to the drive shaft 4 in a torque-transmitting manner via exactly one clutch 8 (FIG. 1) or in each case via a clutch 8, 9 (FIG. 2) in a torque-transmitting manner. The first output shaft 6 can be braked by means of a first brake 10 and the second output shaft 7 can be braked by means of a second brake 11.

The output shafts 6, 7 are each connected to a wheel 21, 22 of the motor vehicle 2.

The drive module 1 has a control unit 23.

The at least one clutch 8, 9 is arranged on the axle 5 of the motor vehicle 2 for the transmission of torques, so that by operating the one clutch 8, 9 (see FIG. 1) both output shafts 6, 7 are connected to the input shaft 4. In the second design variant, the first wheel 21 of the axle 5 is connected to the drive unit 3 in a torque-transmitting manner by actuating the first clutch 8, and the second wheel 22 of the same axle 5 of the motor vehicle 2 is connected to the drive unit 3 in a torque-transmitting manner by actuating the second clutch 9. The clutches 8, 9 are therefore not a clutch of a motor vehicle 2, which is arranged between the drive unit 4 and a shiftable transmission 17 of the motor vehicle 2.

Either exactly one clutch 8 (FIG. 1) or two clutches 8, 9 (FIG. 2) is/are provided on the axle 5. According to FIG. 1, the two output shafts 6, 7 can be decoupled from the input shaft 4 via the one clutch 8. If two clutches 8, 9 (FIG. 2) are provided, each output shaft 6, 7 can be decoupled from the input shaft 4 by means of one clutch 8, 9 in each case.

A brake 10, 11 is assigned to each driven shaft 6, 7 or each wheel 21, 22 of the axle 5 of the motor vehicle 2.

In FIG. 1, an actuating unit 12 is provided, via which both brakes 10, 11 and one clutch 8 can be actuated.

In FIG. 2, two actuation units 12, 13 are provided, whereby one brake 10, 11 and one clutch 8, 9 can be actuated via each actuation unit 12, 13.

The generally known actuation unit 12, 13 is used to actuate a brake 10, 11, i.e. to adjust the brake 10, 11 between an open and a closed state. In the open state, there is no braking effect. In the closed state, there is a maximum braking effect.

The generally known actuating unit 12, 13 serves to actuate a clutch 8, 9, that is to adjust the clutch 8, 9 between an open and a closed (locked) state. In the open state, there is no coupling between the input shaft 4 and the output shaft 6, 7, which can be connected to the input shaft 4 via the clutch 8, 9. In the closed or locked state, there is a coupling between the input shaft 4 and the output shaft 6, 7, which can be connected to the input shaft 4 via the clutch 8, 9 with the drive shaft 4. In the closed state, there is a slip-free coupling, i.e. the drive shaft 4 and the output shaft 6, 7 connected to it have no speed difference. A freely adjustable coupling can be realized via the respective clutch 8, 9, i.e. slip, i.e. a speed difference between the input shaft 4 and the output shaft 6, 7, can be permitted or set.

The actuation unit 12, 13 proposed here serves to actuate the brake 10, 11 and the clutch 8, 9. This means that a common actuation unit 12, 13 is proposed for at least one clutch 8, 9 and one brake 10, 11, so that the drive module 1 is equipped with a smaller number of components.

The drive module 1 according to FIG. 1 has only one clutch 8 and the output shafts 6, 7 and the clutch 8 are connected to the input shaft 4 via a common differential 14.

The two clutches 8, 9 provided as shown in FIG. 2 can replace the otherwise conventional differential 14, by means of which different speeds of the wheels 21, 22 can be compensated.

The drive module 1 comprises a housing 16, in which the clutches 8, 9 and the brakes 10, 11 as well as the actuating units 12, 13 are arranged. The housing 16 encloses a volume that is separated from the environment of drive module 1, so that, for example, particles generated within the housing 16 cannot escape into the environment. Within the housing 16 of drive module 1, there are partial volumes that are separated from each other. For example, each brake 10, 11 and the components of the brakes 10, 11, which interact in a force-locking manner to generate the braking effect, are arranged within their own volume, so that particles generated by the brake 10, 11 cannot contaminate other components of the drive module 1.

The brakes 10, 11 are supported on the housing 16 of the drive module 1.

The output shafts 6, 7 are connected to the input shaft 4 via a gearbox 17 that has a constant gear ratio.

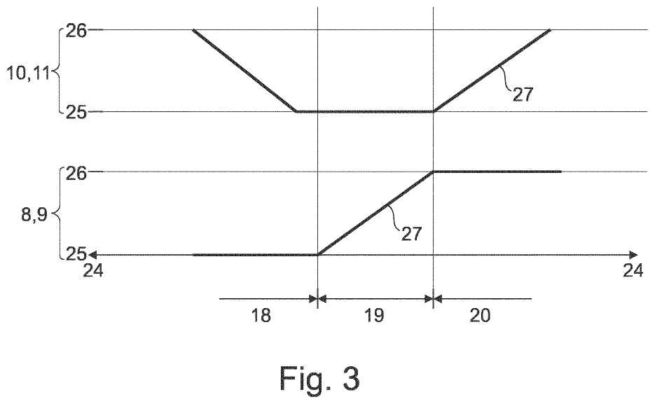

FIG. 3 shows a diagram. The horizontal axis shows the time 24. The vertical axis shows the states 25, 26 of the brake 10, 11 (top) and the states 25, 26 of the clutch 8, 9. The courses 27 shown in the diagram indicate the coordinated states 25, 26 of the clutches 8, 9 and brakes 10, 11. Reference is made to the explanations regarding FIGS. 1 and 2.

In step a) of the method, the (respective) brake 10, 11 is actuated with the actuating unit 12, 13, so that the (respective) output shaft 6, 7 is braked. The second state 26 denotes the closed brake 10, 11, in which the output shaft 6, 7 is therefore braked with maximum effect. The first state 25 denotes the open brake 10, 11, in which there is no braking effect. It can be seen that in a first time interval 18 and towards the second time interval 19 the brake 10, 11 changes from the second state 26 to the first state 25. In the second time interval 19 the brake 10, 11 is open, so the first state 25 is present. In the third time interval 20 and starting from the first state 25, the brake 10, 11 closes again, so that in the third time interval 20 the second state 26 is assumed.

In step b) of the method, the clutch 8, 9 is actuated with the actuating unit 12, 13, so that the output shafts 6, 7 are adjustably connected to the input shaft 4 of the drive unit 4 or the output shafts 6, 7 become adjustable by the input shaft 4 of the drive unit 4. In the first time interval 18, the clutch 8, 9 is open, i.e. it is in the first state 25. In the second time interval 19, the clutch 8, 9 is actuated, i.e. the state of the clutch 8, 9 is between the open state and the closed state. In the third time interval 20, the clutch 8, 9 is closed (or is operated with a slip that has a speed difference of less than 50 revolutions per minute) and is present in a second state 26.

The steps a) and b) are carried out in different time intervals 18, 19, 20, so that when the clutch 8, 9 regulates a connection between the drive shaft 4 and the at least one output shaft 6, 7, the (respective) brake 10, 11 is open and is not actuated. However, the brake 10, 11 can also be either actuated or is actuated when the clutch 8, 9 is closed, e.g. in recuperation mode.

From the progression of the state 25, 26 of the brakes 10, 11 in the first time interval, it can be seen that, if necessary, a time interval can be set between the first state 25 of the brake 10, 11 being reached and the start of the control of the clutch 8, 9. However, if necessary, this time interval can also be reduced to zero or be zero.

1. A drive module of a motor vehicle, comprising at least a drive unit with a drive shaft and an axle of the motor vehicle with a first output shaft and a second output shaft which can be connected to the drive shaft in a torque-transmitting manner via at least one clutch or in each case via a clutch; the first output shaft being brakable by means of a first brake and the second output shaft being brakable by means of a second brake; at least one of the brakes and the at least one clutch being actuatable by means of a common actuating unit.

2. The drive module according to claim 1, wherein the drive module has only one clutch and the output shafts and the clutch are connected to the input shaft via a common differential.

3. The drive module according to claim 1, having a first clutch and a second clutch, wherein the first brake and the first clutch can be actuated via a first actuation unit and the second brake and the second clutch can be actuated via a second actuation unit.

4. The drive module according to claim 3, wherein the actuating units are in each case hydraulic actuating units which actuate the brake and the clutch the actuating units having a common pump by means of which the fluid can be pressurized.

5. The drive module according to claim 1, wherein the at least one clutch is a slip-controlled clutch, by means of which, by providing a slip, torque provided by the drive unit can be transmitted in a controllable manner to the output shaft connected to the drive unit via the clutch.

6. The drive module according to claim 1, wherein the brakes are supported on a housing of the drive module

7. The drive module according to claim 1, at least comprising a housing in which at least the at least one clutch and the brakes as well as the at least one actuating unit are arranged.

8. The drive module according to claim 1, wherein the output shafts are connected to the input shaft via a gearbox with a constant or variable transmission ratio.

9. A method for actuating a brake and a clutch of a drive module according to claim 1, wherein at least one brake and at least one clutch are actuated by the at least one common actuation unit and thus the operation of at least one of the output shafts is controlled; at least comprising the following steps:
a) actuating the brake by means of the actuating unit so that the output shaft is braked;
b) operating the clutch with the actuating unit so that at least one of the output shafts is adjustably connected to the input shaft of the drive unit or is adjustable by the input shaft of the drive unit.

10. The method according to claim 9, wherein steps a) and b) are carried out at different time intervals from one another, so that when the clutch regulates a connection between the input shaft and the at least one output shaft the brake is open and is not actuated.

11. The method according to claim 9, wherein steps a) and b) are carried out at least partially in parallel in time.

12. The method according to claim 9, wherein the at least one clutch is a slip-controlled clutch; wherein, when controlling a torque to be transmitted between the input shaft and at least the one output shaft, a rotational speed difference between the input shaft and the at least one output shaft of more than zero revolutions per minute and of at most 50 revolutions per minute is set.

13. A motor vehicle comprising at least two wheels and a drive module according to one claim 1 for at least one axle of the motor vehicle on which the wheels are arranged, the drive module having a control unit which is set up to carry out a method according to claim 9.
